(19) United States
(12) Patent Application Publication
(10) Pub. No.: US 2018/0227988 A1
(43) Pub. Date: Aug. 9, 2018

(54) Portable Induction Stove Assembly

(71) Applicant: Sherylann Wade, Hesperia, CA (US)

(72) Inventor: Sherylann Wade, Hesperia, CA (US)

(21) Appl. No.: 15/426,686

(22) Filed: Feb. 7, 2017

(51) Int. Cl. H05B 6/12; H02J 7/00; H02M 7/44

(52) U.S. Cl. CPC H05B 6/1209; H02J 2007/0059; H02M 7/44; H02J 7/0052

(57) ABSTRACT

A portable induction stove assembly includes an induction unit that is selectively carried into a remote location. A ferromagnetic container is selectively positioned on the induction unit. The induction unit heats the ferromagnetic container for cooking in the remote location. A power unit is coupled to the induction unit and the power unit is in electrical communication with the induction unit. The power unit converts solar energy into electrical energy thereby facilitating the induction unit to function in the remote location. Moreover, the power unit is selectively electrically coupled to an extrinsic electronic device to charge the extrinsic electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to stove devices and more particularly pertains to a new stove device for cooking without an open flame.

### BRIEF SUMMARY OF THE INVENTION

An embodiment of the disclosure meets the needs presented above by generally comprising an induction unit that is selectively carried into a remote location. A ferromagnetic container is selectively positioned on the induction unit. The induction unit heats the ferromagnetic container for cooking in the remote location. A power unit is coupled to the induction unit and the power unit is in electrical communication with the induction unit. The power unit converts solar energy into electrical energy thereby facilitating the induction unit to function in the remote location. Moreover, the power unit is selectively electrically coupled to an extrinsic electronic device to charge the extrinsic electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a portable induction stove assembly according to an embodiment of the disclosure.

FIG. 2 is a bottom phantom view of an embodiment of the disclosure.

FIG. 3 is a left side phantom view of an embodiment of the disclosure.

FIG. 4 is a top view of an embodiment of the disclosure.

FIG. 5 is a back phantom view of an embodiment of the disclosure.

FIG. 6 is a schematic view of an embodiment of the disclosure.

### DETAILED DESCRIPTION OF THE INVENTION

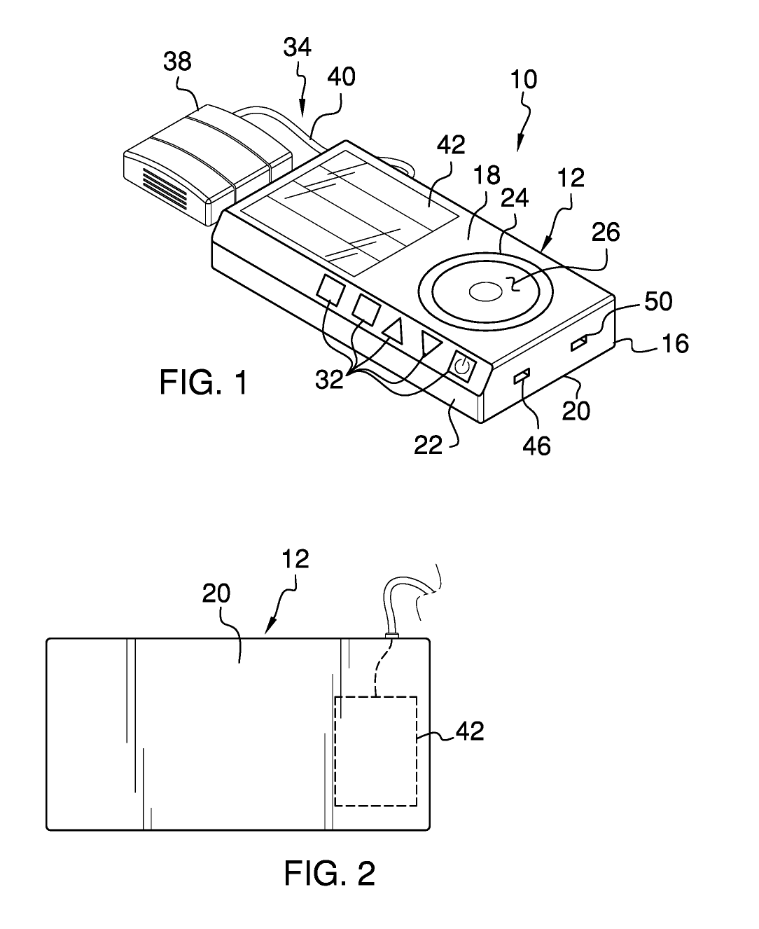

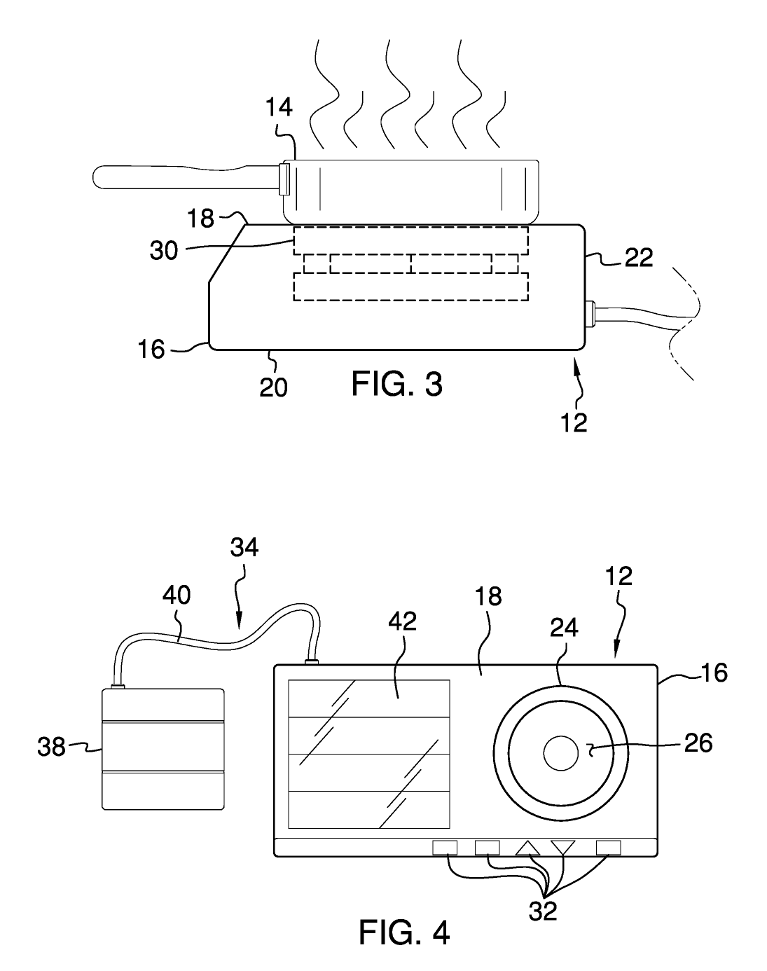

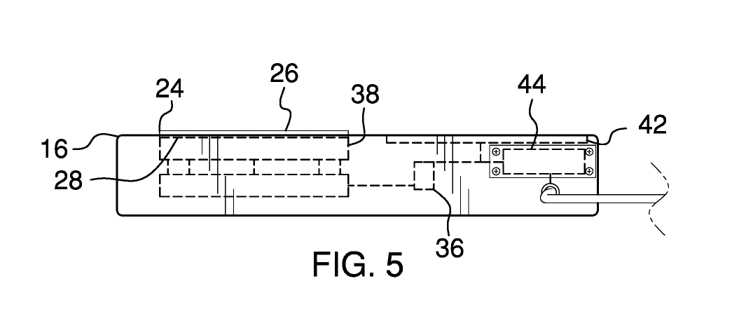

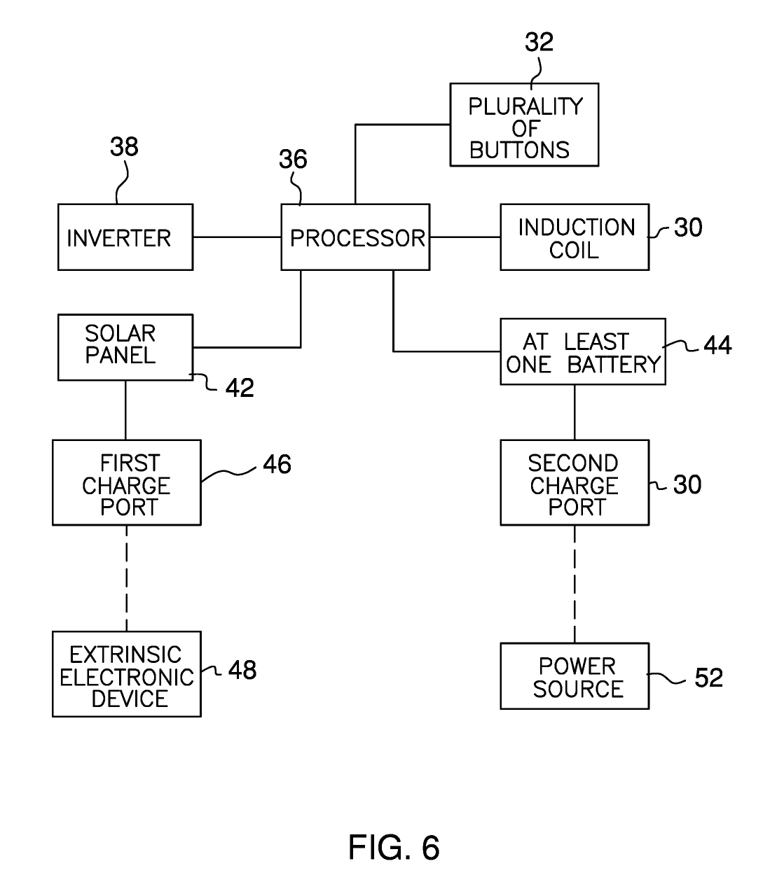

With reference now to the drawings, and in particular to FIGS. 1 through 6 thereof, a new stove device embodying the principles and concepts of an embodiment of the disclosure and generally designated by the reference numeral 10 will be described.

As best illustrated in FIGS. 1 through 6, the portable induction stove assembly 10 generally comprises an induction unit 12 that may be carried into a remote location. The remote location may be a camp site or other location that does not have access to electrical power. Moreover, the remote location may be a location that is at high risk of wildfires resulting from open campfires or open cooking fires. A ferromagnetic container 14 is selectively positioned on the induction unit 12. The induction unit 12 selectively heats the ferromagnetic container 14 for cooking in the remote location.

The induction unit 12 comprises a housing 16 that has a top wall 18, a bottom wall 20 and an outer wall 22 extending therebetween. A plate 24 is provided that has a top surface 26 and a bottom surface 28. The bottom surface 28 is coupled to the top wall 18 of the housing 16 and the ferromagnetic container 14 is selectively positioned on the top surface 26. The plate 24 is comprised of a non magnetic material such as glass, ceramic or other non metallic material.

An induction coil 30 is positioned within the housing 16 and the induction coil 30 is aligned with the plate 24. The induction coil 30 generates a magnetic field when the induction coil 30 is turned on. In this way the induction coil 30 heats the ferromagnetic container 14 when the ferromagnetic container 14 is placed on the plate 24. The ferromagnetic container 14 may be an iron pot, an iron skillet or other similar cooking container.

A plurality of buttons 32 is provided and each of the buttons 32 is movably coupled to the housing 16. The plurality of buttons 32 controls operational parameters of the induction coil 30. The plurality of buttons 32 may include a power button, a temperature up bottom, a temperature down button, a solar button and a battery button.

A power unit 34 is provided and the power unit 34 is coupled to the induction unit 12. The power unit 34 is in electrical communication with the induction unit 12. Moreover, the power unit 34 converts solar energy into electrical energy thereby facilitating the induction unit 12 to function in the remote location. The power unit 34 comprises a processor 36 that is positioned within the housing 16. The processor 36 is electrically coupled to the plurality of buttons 32 and the processor 36 is electrically coupled to the induction coil 30. The processor 36 may be an electronic processor or the like.

An inverter 38 is provided to convert DC current to AC current. The inverter 38 may be a self contained inverter of any conventional design. Additionally, the inverter 38 may have an operational output ranging between 110.0 VAC and 120.0 VAC. A power cord 40 is coupled between the inverter 38 and the housing 16 and the power cord 40 is electrically coupled between the inverter 38 and the induction coil 30. Additionally, the power cord 40 is in electrical communication with the processor 36.

A solar panel 42 is coupled to the top wall 18 of the housing 16 thereby facilitating the solar panel 42 to be exposed to sunlight. The solar panel 42 is electrically coupled to the processor 36. Moreover, the solar panel 42 is electrically coupled to the power cord 40 to facilitate the inverter 38 to convert DC current from the solar panel 42 into AC current. In this way the solar panel 42 selectively powers the induction coil 30.

At least one battery 44 is provided and the at least one battery 44 is positioned within the housing 16. The at least one battery 44 is electrically coupled to the processor 36 and the at least one battery 44 is electrically coupled to the power cord 40. The inverter 38 converts DC current from the at least one battery 44 into AC current. In this way the at least one battery 44 selectively powers the induction coil 30.

A first charge port 46 is coupled to the housing 16 and the first charge port 46 is electrically coupled to the solar panel 42 and the at least one battery 44. The first charge port 46 is selectively electrically coupled to an extrinsic electronic device 48 thereby facilitating the solar panel 42 to charge the extrinsic electronic device 48 when sufficient sunlight is available. The at least one battery 44 charges the extrinsic electronic device 48 when sufficient sunlight is not available. The extrinsic electronic device 48 may be a cellular phone or other similar battery powered electronic device 48.

A second charge port 50 is coupled to the housing 16 and the second charge port 50 is electrically coupled to the at least one battery 44. The second charge port 50 is selectively electrically coupled to a power source 52 to charge the at least one battery 44. The power source 52 may be an external battery charger or the like.

In use, the housing 16 and the inverter 38 are carried to the remote location for camping or other recreational purposes. The ferromagnetic container 14 is positioned on the top surface 26 of the plate 24 for cooking. The power button is manipulated to turn the induction coil 30 on. The solar button is manipulated to power the induction coil 30 from the solar panel 42 when sufficient sunlight is available for powering the induction coil 30. The battery button is manipulated to power the induction coil 30 from the battery when sufficient sunlight is not available. The induction coil 30 induces a magnetic field into the ferromagnetic container 14 thereby heating the ferromagnetic container 14 for cooking without a flame. In this way the induction coil 30 facilitates cooking without posing a risk of wildfires. The extrinsic electronic device 48 is selectively electrically coupled to the first charge port 46 for charging the extrinsic electronic device 48. The second charge port 50 is selectively electrically coupled to the power source 52 to charge the at least one battery 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable induction stove assembly being configured to cook in a remote location, said assembly comprising:
an induction unit being configured to be carried into a remote location, said induction unit being configured to have a ferromagnetic container positioned thereon thereby facilitating said induction unit to heat the ferromagnetic container for cooking in the remote location;
a power unit being coupled to said induction unit, said power unit being in electrical communication with said induction unit, said power unit being configured to convert solar energy into electrical energy thereby facilitating said induction unit to function in the remote location, said power unit being configured to be selectively electrically coupled to an extrinsic electronic device to charge the extrinsic electronic device.

2. The assembly according to claim 1, further comprising said induction unit comprises a housing having a top wall, a bottom wall and an outer wall extending therebetween.

3. The assembly according to claim 2, further comprising a plate having a top surface and a bottom surface, said bottom surface being coupled to said top wall of said housing, said top surface being configured to have the ferromagnetic container positioned thereon, said plate being comprised of a non magnetic material.

4. The assembly according to claim 3, further comprising an induction coil being positioned within said housing, said induction coil being aligned with said plate, said induction coil generating a magnetic field when said induction coil is turned on wherein said induction coil is configured to heat the ferromagnetic container.

5. The assembly according to claim 5, further comprising a plurality of buttons, each of said buttons being movably coupled to said housing wherein each of said buttons is configured to be manipulated, said plurality of buttons controlling operational parameters of said induction coil.

6. The assembly according to claim 1, wherein said power unit comprises an inverter being configured to convert DC current to AC current.

7. The assembly according to claim 6, further comprising:
a housing having a top wall;
an induction coil; and
a power cord being coupled between said inverter and said housing, said power cord being electrically coupled between said inverter and said induction coil.

8. The assembly according to claim 7, further comprising:
a processor; and
a solar panel being coupled to said top wall of said housing wherein said solar panel is configured to be exposed to sunlight, said solar panel being electrically coupled to said processor, said solar panel being electrically coupled to said power cord wherein said inverter is configured to convert DC current from said solar panel into AC current, said solar panel selectively powering said induction coil.

9. The assembly according to claim 7, further comprising:
a processor; and
at least one battery being positioned within said housing, said at least one battery being electrically coupled to said processor, said at least one battery being electrically coupled to said power cord wherein said inverter is configured to convert DC current from said at least one battery into AC current, said at least one battery selectively powering said induction coil.

10. The assembly according to claim 8, further comprising a first charge port being coupled to said housing, said first charge port being electrically coupled to said solar panel, said first charge port being configured to be electrically coupled to an extrinsic electronic device thereby facilitating said solar panel to charge the extrinsic electronic device.

11. The assembly according to claim 9, further comprising a second charge port being coupled to said housing, said second charge port being electrically coupled to said at least one battery, said second charge port being configured to be electrically coupled to a power source to charge said at least one battery.

12. A portable induction stove assembly being configured to cook in a remote location, said assembly comprising:
an induction unit being configured to be carried into a remote location, said induction unit being configured to have a ferromagnetic container positioned thereon thereby facilitating said induction unit to heat the ferromagnetic container for cooking in the remote location, said induction unit comprising:
a housing having a top wall, a bottom wall and an outer wall extending therebetween,
a plate having a top surface and a bottom surface, said bottom surface being coupled to said top wall of said housing, said top surface being configured to have the ferromagnetic container positioned thereon, said plate being comprised of a non magnetic material,
an induction coil being positioned within said housing, said induction coil being aligned with said plate, said induction coil generating a magnetic field when said induction coil is turned on wherein said induction coil is configured to heat the ferromagnetic container, and
a plurality of buttons, each of said buttons being movably coupled to said housing wherein each of said buttons is configured to be manipulated, said plurality of buttons controlling operational parameters of said induction coil; and
a power unit being coupled to said induction unit, said power unit being in electrical communication with said induction unit, said power unit being configured to convert solar energy into electrical energy thereby facilitating said induction unit to function in the remote location, said power unit being configured to be selectively electrically coupled to an extrinsic electronic device to charge the extrinsic electronic device, said power unit comprising:
a processor being positioned within said housing, said processor being electrically coupled to said plurality of buttons, said processor being electrically coupled to said induction coil,
an inverter being configured to convert DC current to AC current,
a power cord being coupled between said inverter and said housing, said power cord being electrically coupled between said inverter and said induction coil,
a solar panel being coupled to said top wall of said housing wherein said solar panel is configured to be exposed to sunlight, said solar panel being electrically coupled to said processor, said solar panel being electrically coupled to said power cord wherein said inverter is configured to convert DC current from said solar panel into AC current, said solar panel selectively powering said induction coil,
at least one battery being positioned within said housing, said at least one battery being electrically coupled to said processor, said at least one battery being electrically coupled to said power cord wherein said inverter is configured to convert DC current from said at least one battery into AC current, said at least one battery selectively powering said induction coil,
a first charge port being coupled to said housing, said first charge port being electrically coupled to said solar panel, said first charge port being configured to be electrically coupled to an extrinsic electronic device thereby facilitating said solar panel to charge the extrinsic electronic device, and
a second charge port being coupled to said housing, said second charge port being electrically coupled to said at least one battery, said second charge port being configured to be electrically coupled to a power source to charge said at least one battery.
